(19) United States
(12) Patent Application Publication
(10) Pub. No.: US 2014/0303994 A1
(43) Pub. Date: Oct. 9, 2014

(54) INTERACTIVE MONITOR SYSTEM FOR A MEDICAL CAMPUS

(71) Applicant: Lanny L. Johnson, Frankfort, MI (US)

(72) Inventor: Lanny L. Johnson, Frankfort, MI (US)

(21) Appl. No.: 14/287,160

(22) Filed: May 26, 2014

Related U.S. Application Data
(63) Continuation-in-part of application No. 12/537,942, filed on Aug. 7, 2009, now Pat. No. 8,734,160.
Application No. 12/537,942 is a division of application No. 11/744,978, filed on May 7, 2007, now Pat. No. 7,572,127.
Application No. 11/744,978 is a continuation of application No. 11/551,862, filed on Oct. 23, 2006, now abandoned.

(51) Int. Cl. G06F 19/00

(52) U.S. Cl. CPC G06F 19/3418
USPC 705/2

(57) ABSTRACT

An interactive systems and method for providing medical or emergency information across a medical campus including a master computer that receives, stores and selectively transmits medical or emergency information to a plurality of interactive monitors, which are accessible by a plurality of users.

### CROSS-REFERENCE TO RELATED APPLICATIONS

This application is a continuation-in-part of U.S. patent application Ser. No. 12/537,942, filed Aug. 7, 2009, which is a divisional application of U.S. patent application Ser. No. 11/744,987, filed May 7, 2007, now U.S. Pat. No. 7,572,127, which is itself a continuation of U.S. patent application Ser. No. 11/551,862, filed Oct. 23, 2006, now abandoned.

### FIELD OF INVENTION

The present invention provides systems and methods for the interactive display of information across a medical campus and more particularly to systems and methods for selectively delivering educational and emergency information to physicians and medical personnel at various locations throughout a medical campus by communicatively networking a master computer with a plurality of interactive monitors, each accessible through one or more user transmitters.

### BACKGROUND OF THE INVENTION

Due to recent federal legislation as well as new educational institutional policies, pharmaceutical and medical device companies are banned from providing any significant financial assistance or incentive to the doctors or the medical staff in order to promote their products or services. Traditional marketing methods included the use of company employees to entertain, gift, or otherwise incentive medical personnel to listen to or to see presentations concerning the respective company's products or services. In response to the loss of this traditional method, the medical companies have taken to marketing their products directly to the public via commercial media, i.e. television, magazines, newspapers. The thrust of such marketing is to motivate the potential patient to ask their doctor about the product. Often, this is the first notification of such a product. It is no longer the direct relationship with the supplier for information, but it is the patient who is now the agent of information. This method often is confusing to the patient who may lack medical understanding and novel to the physician or staff who was not prepared educationally to respond to the patient's inquiry. The problem now is how to get this timely educational information to the medical profession. Continuing medical education is provided by the hospitals, universities, and medical societies, but these are monthly or less frequent.

This problem is further complicated by the doctor's and staffs available time being limited. Daily patient care activities minimize or eliminate daily education opportunity. There is little time available on a daily basis to learn about the new products or services of the pharmaceutical or medical device companies for the above reasons. Further, with the growing amount of information available it can be difficult to direct particular information to certain physicians.

### SUMMARY OF THE INVENTION

The present invention provides interactive systems and methods for providing medical or emergency information across a medical campus. This is accomplished by providing a master computer that receives, stores and selectively transmits information to a plurality of interactive monitors, which are accessible by a plurality of users. Users access the interactive monitors using an assigned user identifier among a plurality of user identifiers. Once operably connected, the user may selectively view information stored in memory or information streamed in real time or near real time from the master computer. Thus, by permitting updates from those that supply medical or emergency information medical personnel are able to timely receive educational and emergency updates with fewer concerns regarding recent legislation and administrative burdens.

Transmission of information from the master computer to the plurality of interactive monitors is regulated by one or more identifiers, which may be a monitor identifier or a user identifier. In some embodiments the master computer includes software that receives stores and transmits a plurality of programs including medical or emergency information, the transmission of which is selectively accessed or authorized by a plurality of monitor identifiers. Monitor identifiers identify a particular interactive monitor or may identify a class or subset of all interactive monitors on the medical campus. The interactive monitor is then accessed by users via a transmission of a corresponding user identifier. In an exemplary system, a user identifier is transmitted by a user transmitter for recognition by the CPU of the interactive monitor. Upon recognition of the user identifier, the CPU permits access to at least one group of programs for display at the interactive monitor.

Though interactive monitors may be individually assigned a monitor identifier, interactive monitors may be classified or defined as belonging to at least one class among a plurality of monitor classes. Exemplary monitor classes include those associated with a scrub sink, an operating room, a physician's office, a physicians' lounge, a laboratory, an interventional radiology area, a radiology reading area, a utility instrumentation room, a sterilization room, a patient educational area, a pharmacy or any other department or region of a medical campus. The interactive monitor may be updated with information for display of programs hourly, daily, weekly or the like from the master computer. In some embodiments information is streamed in real-time or near real-time such as having a few second or minute delay as desired transfer or display technology permits.

In some embodiments the master computer includes software that receives, stores and transmits a plurality of programs including medical or emergency information, the transmission of which is selectively accessed or authorized by a plurality of users through user identifiers. In an exemplary system the user identifier is transmitted to the interactive monitor, which receives and if accepted transmits the user identifier or a secondary user identifier to the master computer to permit receipt of information.

In some embodiments, a wireless device, such as a smart phone, tablet computer, or wearable visible technology such as Google Glass, or other heads-up-display device such as augmented reality glasses, collectively referred to herein as smartglasses, or smartwatch technology, is adapted for use as an interactive monitor. In such a system the wireless device is loaded with programming to recognize the user identifier. Transmission of the user identifier may be performed through blue tooth connectivity, transmission of an assigned RFID, voice command, and the like.

The present invention also includes methods of selectively accessing medical or emergency information across a medical campus through the use of the interactive system. The methods include providing the interactive system, loading programming into the master computer and grouping the programming or information to permit access by a plurality of interactive monitors, positioning a plurality of interactive monitors throughout the medical campus, and assigning a plurality of user identifiers to a plurality of users.

### BRIEF DESCRIPTION OF THE DRAWINGS

Without limiting the scope of the system as claimed below and referring now to the drawings and figures:

FIG. 1 provides a system including a master computer operably connected to a plurality of interactive monitors, which are accessible through a plurality of user transmitters. The master computer is shown connected via the Internet to an account holder for uploading of programming or information;

FIG. 2 provides exemplary features of an interactive monitor, which include a central processing unit (CPU) to control operations; memory, for retaining long term and short term storage of information; a display, which permits viewing of video information; a power source, such as a battery to provide power; a transceiver, which provides transmitter and receiver functions; and a user interface, which may include video input, microphone, keypad and data input jack;

FIG. 3 provides an exemplary placement of the interactive monitor at a surgeon scrub sink;

FIG. 4 provides an embodiment using a smart phone as an interactive monitor; and

FIG. 5 provides a schematic of various aspects of an embodiment of the system.

These drawings are provided to assist in the understanding of the exemplary embodiments of the system as described in more detail below and should not be construed as unduly limiting the system. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF PREFERRED EMBODIMENTS

The present invention provides an interactive system for use throughout a medical campus, for the selective display of medical or emergency information. Exemplary programming or information may be any that a physician or medical professional would find useful, such as pharmaceutical information, medical device information, medical instruction information, emergency information and the like. The medical campus will benefit by enhanced distribution of information across the medical campus, which may be tailored or sorted according to interest of the physician or medical department.

### DEFINITIONS

Unless defined otherwise, all technical and scientific terms used herein have the same meaning as is commonly understood by one of ordinary skill in the art to which this invention belongs. The following definitions are provided as further clarity for those skilled in the present art.

The term “medical campus” as used herein refers to a medical institution, which includes a plurality of medical departments or practice groups.

The term “master computer” as used herein refers to one or more computer systems, which control the distribution of programming or information to the interactive monitors. The master computer may be a server which maintains a series of connected interactive monitors. The master computer may host a variety of hosted accounts for account holders, which allows uploading of programming or information from a remote source.

The term “interactive monitors” as used herein refers to terminals operably connectable with the master computer, with which a user may interact. Interaction with an interactive monitor is initiated by a user through transmission of a user identifier. Once accessed the interactive monitor permits the user to control receipt of information by responding to a series of commands including those that choose from a listing of menu options, stopping, starting or changing programming and the like. The interactive monitors are each able to connect to the master computer; however, connection between interactive monitors is not required.

The term “radio frequency identification” or “RFID” as used herein refers to a combined tag and tag reader that can be linked to the networked system to identify the device or user associated with the tag. RFID includes active, semi-active and passive RFID tags. Data on RFID tags can be changed, updated and locked. RFID tags may be integrated into a card, such as a microSD card for insertion into a microSD card slot in a smartphone and the like, which can be used to identify a user for access to the programming or information.

The term “Bluetooth” as used herein refers to a short-range wireless protocol for exchanging data over short distances using short length radio waves from fixed and mobile devices creating personal area networks. Bluetooth may be used to transmit a user identifier from a user transmitter to the interactive monitor for recognition.

The term “upload” or “uploading” as used herein refers to sending data from a local system to a remote system such as a server with the intent that the remote system should store of a copy of the data being transferred. Programming or information may be uploaded to the master computer for distribution across a plurality of interactive monitors.

The term “download” or “downloading” as used herein refers to sending data to the interactive monitor from the master computer.

The term “stream” or “streaming” as used herein refers to viewing information at the interactive monitor while the corresponding file is being accessed from the master computer.

The term “hosted account” as used herein refers to memory allocated to an account holder to upload medical or emergency information. The hosted account may include features which permit choosing or entry of descriptive options to assist with classifying the content of the medical or emergency information for distribution across the system.

The term “account holder” as used herein refers to a company or individual, which is capable of uploading medical or emergency information to the master computer for storage and transfer to interactive monitors. The account holder is most often a medical device company or pharmaceutical company.

As an introduction, the interactive system includes a master computer, a plurality of interactive monitors and a plurality of transmitters, in some embodiments. The master computer includes software that receives, stores and transmits a plurality of programs to the interactive monitors, which may include medical or emergency information, the transmission of which is selectively accessed according to identifiers. The interactive monitor includes a central processing unit (CPU) operably connected to memory, a display screen and a transmitter. Users selectively access the interactive monitor by transmitting a corresponding user identifier. Accordingly, upon approval the user is able to selectively access at least one group of programs for display.

In preferred embodiments, information is distributed to a plurality of interactive monitors through a master computer. That is, the master computer provides a central computer for receiving, storing and transmitting information to the desired interactive monitor and thus user. Operationally, the master computer has a central processing unit (CPU) operably connected to memory, such as read only memory (ROM) and random access memory (RAM). The master computer is loaded with software or programmed to permit receipt, storage and transmission of programming or information. In some embodiments, the master computer is a server, which includes features commonly associated with servers in client-server network configurations.

Programming for the system, which includes medical or emergency information, is received by the master computer through an input means. A variety of input means are known in the computer arts for inputting programming, such as conventional keyboard data entry, downloading over the Internet, PIR to PIR communication, uploading from media such as data disks, DVD, CD, flash memory and the like. In some embodiments, account holders, such as medical or pharmaceutical companies are provided with accounts for uploading programming or information, such as over the Internet for storage on the master computer. Still further, the master computer may include account programming to permit account holders to assist or suggest classifications or identifiers to assist with grouping of information to facilitate appropriate classification or assignment for delivery. In such a system, administrators may view the information to approve or disapprove of the classification and thus edit any desired parameters. Once received the information or programming may be stored in particular folders or tagged or labeled with identifiers to permit the program or information to be selectively accessed as desired. Account holders may also be permitted to upload corporate identifying information such as trademarks, logos, sponsorship information, advertisements and the like. Such identifying information may be displayed between programming or while downloading larger files including desired medical or emergency information. Identifying information may also be stored separately on the interactive monitors for display for any desired use such as screen saver, background, further company information or contact and the like.

The master computer communicates with a plurality of interactive monitors through appropriate cabling as known in the computer or information technology arts or may communicate wirelessly. As such, transmission may be accomplished through a variety of transmission means depending on the needs or desires of the user. Those skilled in the art will appreciate the transmission means may include various network cards or interfaces known in the information technology arts or may include a variety of wireless transmitters and receivers for selectively transmitting and receiving information. The system may be hard wired such as through the use of network cabling with suitable connectors or may be wireless. Transmission and receipt of signals is within the capabilities of one skilled in the information technology and computer arts.

The interactive monitor communicates with the master computer and, in some embodiments, a user transmitter. The interactive monitor itself includes a central processing unit (CPU) operably connected to memory, a display screen, and a transmitter capable of transmitting and receiving signals from the master computer and in some embodiments the user transmitter. The interactive monitor is loaded with software to carryout desired functions. By “interactive” it is meant that the interactive monitor permits the user to provide feedback or commands which instruct the system to provide the particular programming or information the user would like to initiate. Thus, interactive features permit the user to take appropriate action to maintain or adjust the content of the programming. For example, the user may select, skip, begin, end, pause, continue, fast-forward or rewind the programming and the like.

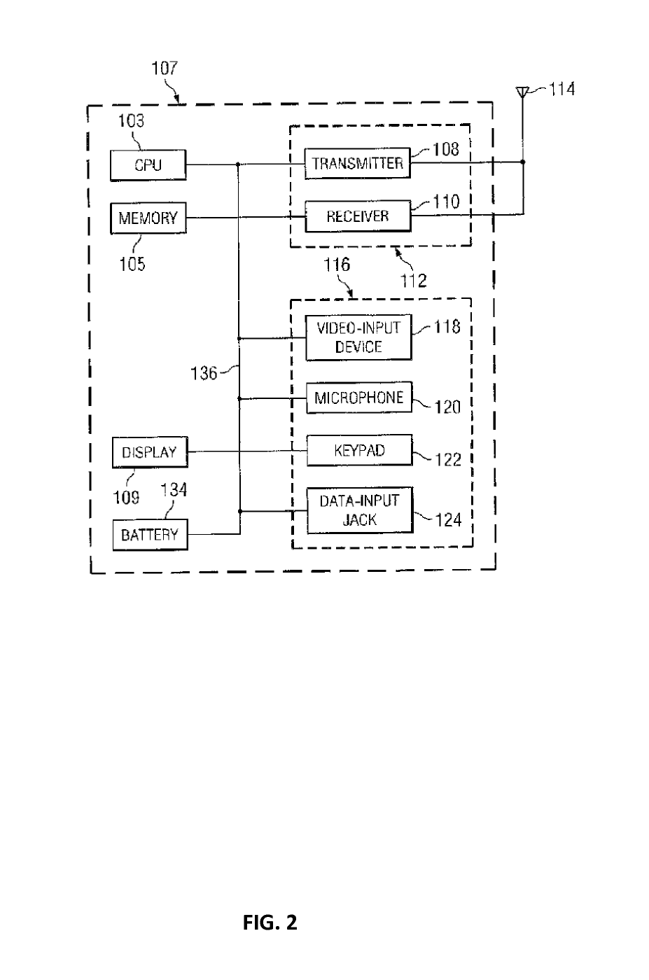

The interactive monitor may include a user-input interface, which can optionally include a video-input device, input audio, commands, video images, voice data and other data may be entered by the user. Although FIG. 2 illustrates the user-input device as including a video-input device to input video such as from medical companies to be displayed, a data-input jack which may connect the interactive monitor to a network or to the Internet so that video and other data can be obtained and stored within the interactive monitor.

Electrical components of the interactive monitor receive power from a power source, such as a battery. In an exemplary embodiment, the battery is a rechargeable battery. In other embodiments, the interactive monitor may include a power connector for connection to an external power source, such as an automobile power adapter, AC power adapter, or the like.

The various components of the interactive monitor may be coupled together by a bus system, which may include a power bus, control bus, and status signal bus in addition to a data bus. For the sake of clarity, however, the various buses are illustrated in FIG. 2 as the bus system.

Functionally, transmission of programming or information from the master computer to the interactive monitor is regulated in part by an identifier, which provides access authorization or a security gateway. The identifier may be a monitor identifier, which is assigned to a particular interactive monitor or group, class or subset of interactive monitors or may be user identifier, which is assigned to a particular user or subset of users.

Monitor identifiers, or monitor ID's for short, may be desired when deploying a plurality of interactive monitors across a medical campus when the medical campus includes defined groups or departments. Potential users within defined departments likely include common medical interests and thus grouping interactive monitors according to a defined class, which correspond to a department or a common feature among the intended users, would provide an efficient means to target delivery of information. For instance, practice groups such as radiology would tend to have different interests than those working in the pharmacy. As such, it may be desirable to assign a first monitor class identifier to radiology and a second monitor class identifier to the pharmacy to enhance the delivery of desired information. Though there may be different monitor classifications or classes, it may be further desirable to include overlap of information. For instance, while orthopedic physicians would tend to have interest in pharmaceuticals useful for the treatment of orthopedic conditions, pharmaceuticals for the treatment of psychiatric conditions may not be of particular interest; however, each may be of interest to the pharmacy. Accordingly, in preferred embodiments a variety of information would be considered appropriate for delivery to two or more practice groups and thus be assigned to two or more interactive monitor classes. Thus, an orthopedics department may be assigned a third class, which overlaps in part with the class assigned to pharmacy. Further, information transmitted to monitors in a lounge area such as a physician's lounge may provide information in alternative or expanded formatting. For instance, it may be desired to include additional information for programming in a physicians lounge as compared to an operating room, where it may be desired to streamline programming. Thus, a lounge area may be assigned a separate class or may be a subset or setting option of a higher order department class.

Assigning or designating programming or information to a monitor identifier or classification may be performed by a systems administrator and may be suggested by an account holder supplying the programming or information. In an exemplary embodiment, the account holder selects from a menu of practice departments or groups for receipt of the programming or information in the account holder's account. Programming of menu options or account input features can be performed by those skilled in the computer programming arts and can include a variety of form features including drop-down lists, radio buttons, text boxes, check boxes and the like. This option will may be particularly useful when receiving federal Food and Drug Administration (FDA) approval for administration of a pharmaceutical for particular medical conditions.

Assigning a monitor identifier to a particular monitor, or class of monitors, may be performed using a variety of coding techniques known to those skilled in the present art. In some embodiments each interactive monitor can be identified such as by bar code scanning for input into system management software. That is, once identified in a system management program, the monitor identifiers permit the interactive monitors to be grouped to form one or more monitor classes or groups. Those skilled in the art will recognize a monitor identifier will assist in the management of the plurality of interactive monitors since the identifiers can be reversibly assigned to any desired class by the system administrator. That is, by assigning a monitor identifier, an administrator may selectively group, change or delete the monitor from any available class. Interactive monitors may also be recognized by an IP address, as known in the information technology arts, which may facilitate its placement on a network.

Monitor identifiers may also be used to regularly update the interactive monitor with information. That is, the interactive monitor may be preloaded with information prior to initiation by the user. Preloading information into memory prior to use may enhance display speed and reduce traffic on a network and thus reduce the potential for delays in access or download times. In some embodiments, the interactive monitor is updated with programming or information hourly, daily or weekly. Still further the system may update interactive monitors with information according to grouping or classification and thus selectively update grouped interactive monitors at desired intervals, which may be different from other groups. Alternatively, interactive monitors may be updated immediately or near immediately once programming or information has been updated in the master computer.

Operationally, the interactive monitor may be electronically operated using any suitable on/off mechanism, such as switches or buttons, any suitable sensor including a motion sensor, voice-activation, and the like. In preferred embodiments a user is assigned a user identifier to selectively access the interactive monitor. In a particular embodiment a user transmitter, which transmits a user identifier, is housed within an ear piece, which may additionally permit the receipt of audio signal from the interactive monitor; although the user identifier may be an audible command, such as a user name and password, spoken by the user.

An optional manual override switch may also be provided to facilitate continued operation of the interactive monitor should there be an interruption in power or signal. This override switch may be operationally linked to a backup battery power pack, which itself may be charged when power is not interrupted. Further, upon detection of power failure the interactive monitor may automatically tune to an emergency channel. That is, the interactive monitor may automatically receive emergency updates.

In some embodiments the interactive monitor is provided as a smartphone, a netbook, a laptop computer, a tablet computer, wearable visible technology such as Google Glass, or other heads-up-display device such as augmented reality glasses, collectively referred to herein as smartglasses, smartwatch technology, or other portable technology, loaded with appropriate software. That is, devices able to transmit and receive information and having sufficient computing power and memory to operate the software are also encompassed by the present invention. A smartphone is a mobile phone offering advanced capabilities, often with PC-like functionality. Smartphones may run their own operating system software, which permits programming of features performed by the interactive monitor. Operating systems that can be found on smartphones and which may be used with the present include Symbian OS, iPhone OS, Palm WebOS, BlackBerry OS, Samsung bada, Windows Mobile, Android, Maemo and the like. WebOS, Android and Maemo are built on top of Linux, and the iPhone OS is derived from the BSD and NeXTSTEP operating systems, which all are related to Unix. Netbooks (sometimes also called mini notebooks or ultraportables) are a branch of subnotebooks, a category of small, light and inexpensive laptop computers suited for general computing and accessing web-based applications; they are often marketed as “companion devices,” that is, to augment a user's other computer access. In the short period since their appearance, netbooks have grown in size and features, now converging with new smaller, lighter notebooks. Some consider them as nothing more than smaller, cheaper notebooks, noting specs are so similar that the average shopper would likely be confused as to why one is better than the other. Operating systems found on netbooks and laptops, which may be used with the present invention include Windows, Linux, Android, Chrome OS, Mac OS X, and the like. In general terms, tablet PC refers to a slate or tablet-shaped mobile computer device, equipped with a touchscreen or stylus. This form factor offers a more mobile computer. A variety of computer manufacturers are further developing tablet PCs including Hewlett-Packard and Apple. Smartglasses include a wide range of heads-up display devices, often referred to augmented reality, or AR, glasses, such as, but not limited to Google Glass, Meta Pro augmented reality glasses, Vuzix smart glasses, Optinvent Ora-S AR glasses, Recon Jet glasses by Recon Industries, GlassUp glasses, Epiphany Eyewear glasses, Telepathy One glasses, just to name a few. Similarly, the interactive monitor may encompass any other present or future portable visual technology including, but not limited to, augmented reality contact lenses and implants, as well as smartclothing, smartwatches, smartjewelry, and the like.

User identifiers, or user ID's for short, may be transmitted using the user transmitter. The user transmitter can be any suitable device which may transmit a code, which can be identified by the interactive monitor. In one embodiment, the user transmitter is provided within an earpiece, however it may be provided within any of the technologies discussed herein. In this embodiment the earpiece transmits a user identifier to the interactive monitor, which identifies the user from a plurality of users. Once the user identifier is accepted the user may initiate the program or receive information. Preferably when providing the earpiece configuration the audio corresponding to the displayed video is received by the earpiece.

A variety of methods and systems permit the transfer of signals, which can be adapted for use with the present invention. Among these include radio-frequency identification (RFID). Generally an RFID tag is applied to or incorporated into a device, which may be an earpiece, glasses, implant, contact lens, watch, clothing, jewelry, badge, and the like. The tags themselves may be read from several meters away and beyond the line of sight of the reader. As such an RFID system may be desired in locations about the medical campus which have obstacles or structures which may interfere with line of sight. There are generally three types of RFID tags: active RFID tags, which contain a battery and can transmit signals autonomously, passive RFID tags, which have no battery and require an external source to provoke signal transmission, and battery assisted passive (BAP) which require an external source to wake up but have significant higher forward link capability providing great read range. RFID tags are becoming increasing prevalent as the price of the technology decreases. For instance microSD cards are being developed, which may be added to a smartphone, to provide both passive tag and an RFID reader. As such, a smartphone or the like having an RFID card inserted therein may permit access and display of information by the system.

In some embodiments, a smartphone is loaded with software able to read an RFID tag. The RFID tag is encoded within a microSD card and inserted into the microSD card slot of the smartphone. The microSD card houses the user identifier, which is read and thus transmitted to the smartphone software for recognition. The software recognizes the user identifier or RFID signal and thus permits access to the network of interactive monitors. The user is then able to interact with the master computer via the smartphone.

Bluetooth is wireless protocol for exchanging data over short distances (using short length radio waves) from fixed and mobile devices, creating personal area networks (PANs). It was originally conceived as a wireless alternative to RS-232 data cables. It can connect several devices, overcoming problems of synchronization. Accordingly, Bluetooth connectivity may be preferred when distances between the user transmitter and interactive monitor are sufficiently short.

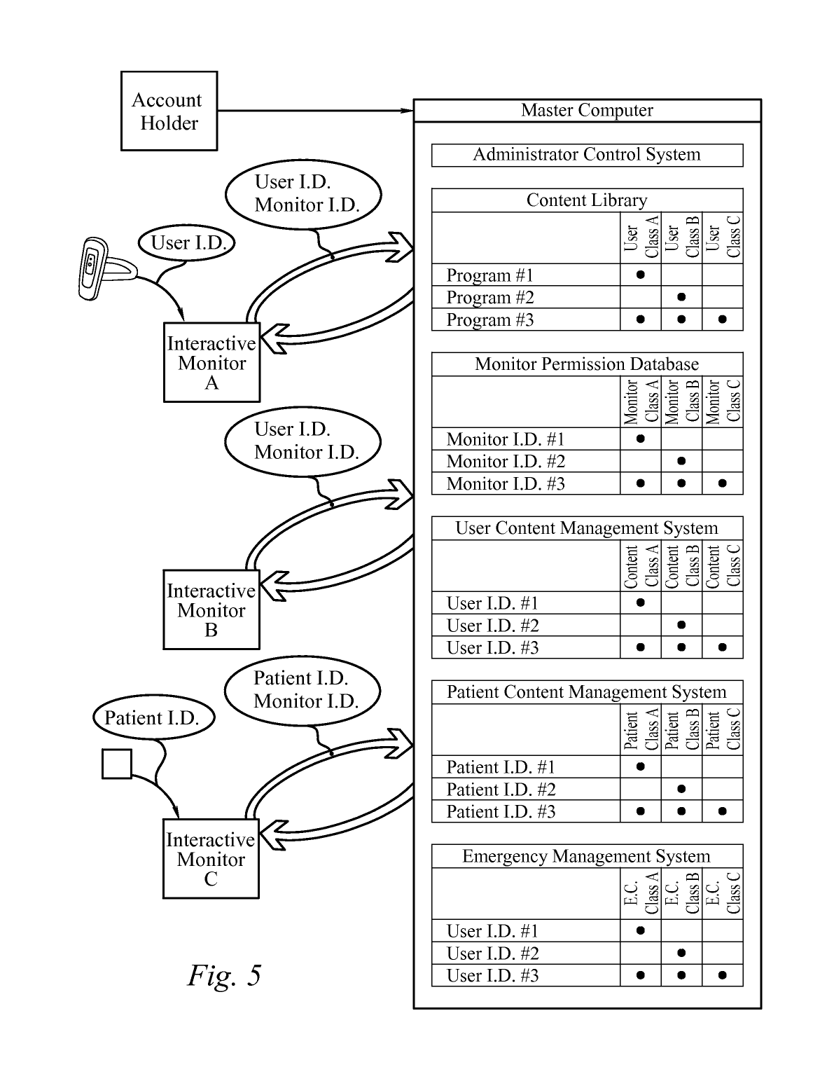

An embodiment of the system is schematically illustrated in FIG. 5. An account holder supplies a plurality of programs and content to the master computer, illustrated as “program #1,” “program #2,” and “program #3.” The account holder creates the “content library” illustrated in FIG. 5 and may assign the content to one or more user classes, exemplarily identified as “user class A,” “user class B,” and “user class C.” User classes may be established to ensure specific programs are available to specific users, generally by the user's practice area and role. Potential users within defined departments likely include common medical interests. For example the account holder may assign “program #1” to “user class A,” which may be pharmacy technicians; while “program #2” may be assigned to a user class, in this example “user class B,” which may be limited to registered pharmacists; and “program #3” is assigned to all three exemplary user classes so that the content is available to pharmacy technicians, registered pharmacists, and “user class C,” which may be pharmacy managers. One skilled in the art will appreciate that an account holder is likely to associate different programs to a practice group such as radiology than the account holder would assign to a practice group such as pharmacy, although it is likely that some programs should be associated with both. Likewise, while orthopedic physicians would tend to have interest in pharmaceuticals useful for the treatment of orthopedic conditions, pharmaceuticals for the treatment of psychiatric conditions may not be of particular interest; however, each may be of interest to the pharmacy. Accordingly, in preferred embodiments a variety of content would be considered appropriate for delivery to two or more practice groups and thus be assigned to two or more user classes.

While the account holder may assign content, or “programs,” to user classes, a system administrator, i.e. someone within the particular healthcare system, associates particular user identifiers, or “user I.D.”'s, to one, or more, user classes via the “administrator control system”; however this step may be automated based upon human resource files and/or classifications. This step provides an extra level of security and ensures the healthcare system has ultimate control over which programs are available to particular users, and when or where the programs are available.

The master computer also includes a “monitor permission database” whereby the system administrator, via the “administrator control system,” associates particular interactive monitors, identified as “monitor I.D. #1,” “monitor I.D. #2,” and “monitor I.D. #3” in FIG. 5, to a particular monitor class, identified as “monitor class A,” “monitor class B,” and “monitor class C.” For instance, in one embodiment all interactive monitors that are smartphones, and thus truly personal viewing devices, may be assigned to all monitor classes, like “monitor I.D. #3” in FIG. 5, so that all the programs available to a particular user are accessible from the smartphone. Further, interactive monitors located in spaces within the line-of-sight of the public may be assigned to a different monitor class so that only publically appropriate programs available to the particular user may be accessed from this particular interactive monitor. Still further, public waiting areas may include interactive monitors assigned to yet another separate monitor class, to further control which programs are viewed in specific locations.

In some embodiments the system also includes a “user content management system” so that the end user has some control of the type of content available to them. For instance, the system administrator may make all surgery related content available to all surgeons, however a particular user may be a hand surgeon, or a foot surgeon, and may wish to not have access to content associated with brain surgery or heart surgery. Thus, in this embodiment the master computer is accessed by the system administrator, the account holder, and the end-user, with the system administrator controlling the actions that may be taken by the account holder and the end-user.

Yet a further embodiment allows a patient to access the system and view programs on an interactive monitor. For instance, the account holder may have a program directed to knee replacement patients that explains the medical device, the surgery, and the physical therapy in a manner appropriate for a patient. Thus, the master computer may include a “patient content management system,” as seen in FIG. 5, whereby the system administrator assigns patients to particular patient classes, such as “patient class A,” patient class B,” and “patient class C,” which allows them to access the programs in the “content library” that have been associated with their patient class, while also being subject to the controls of the “monitor permission database.”

In a further embodiment the master computer includes an emergency management system. For example, the account holder may add content, which we will call “program Z” for illustrative purposes, to the content library and associate it with a user class, which when associated with emergency content we will call “E.C. class A” for the example. The system administrator may then associate particular user I.D.'s with the emergency content class; and the user cannot block, or opt-out of, any programs designated as emergency content. However, just as with the association of non-emergency content with particular user classes, not all emergency content is applicable to all users. For instance, while most, if not all, users should be made aware of emergency content directed to a widely prescribed pain killer, not all users should be associated with emergency content directed to a product recall related to a cochlear implant.

The master computer may further include emergency prioritization system to ensure emergency content is viewed by the users. For instance, in one embodiment the emergency prioritization system prevents a user from accessing non-emergency programming until all emergency content associated with a particular user I.D. has been view in the entirety.

Additionally, local emergency content may be added to the content database by the system administrator. The local emergency content may be associated with particular user classes just as the previously described non-emergency programs. Further, the local emergency content may be pushed out to the interactive monitors to automatically display the content, overriding any other content was currently being accessed on the interactive monitor. Thus, in times of crisis, such as natural disasters or terrorisms, the system administrator may quickly record local emergency content, add it to the content library, and force it out to all, or selected, interactive monitors.

Still referring to FIG. 5, three interactive monitors are illustrated in this example, namely interactive monitor A, B, and C. Interactive monitor A is shown receiving a user I.D. from an earpiece, although it could just as well be any of the previously disclosed equipment, and interactive monitor A transmits the user I.D. and the monitor I.D. to the master computer. The master computer then utilizes the monitor I.D. to determine the monitor class, utilizes the user I.D. to determine the user class, as well as which programs associated with the user class may be displayed on the particular monitor class and makes such programs available to the user. In embodiments incorporating the user content management system, the master computer will also filter out programming that the particular user has excluded from their user profile.

The second interactive monitor in FIG. 5, specifically interactive monitor B, is not shown as receiving an external user I.D., but still transmitting both a user I.D. and a monitor I.D. to the master computer. This would be the case of the previously described situation in which the interactive monitor is a smartphone and the user I.D. is known to the smartphone via an internal card rather than being received from a separate external device. Otherwise the process is the same as that described for interactive monitor A. The last interactive monitor example of FIG. 5 is interactive monitor C, which is illustrated as receiving a patent I.D. and transmitting it along with the monitor I.D. to the master computer. In this situation the master computer then utilizes the monitor I.D. to determine the monitor class, utilizes the patient I.D. to determine the patient class, as well as which programs associated with the patient class may be displayed on the particular monitor class and makes such programs available to the patient.

This interactive monitor system for a medical campus presents a new and unique way of doing business that does not run afoul with modern healthcare laws. In one such method a management company presents the system to a healthcare network and proposes to furnish and install all the hardware and software necessary for the system. Additionally, in exchange for being the sole provider of content to the master computer, aside from the healthcare system itself, the management company agrees to pay the healthcare network a fee. The management company then contracts with vendors such as medical device companies and pharmaceutical companies to provide programs into the content library. These vendors pay a content management fee to the management company to have their materials available to the users located within the healthcare network.

The master computer includes software that receives, stores and transmits a plurality of programs to the interactive monitors, which may include medical or emergency information, the transmission of which is selectively accessed according to identifiers. The interactive monitor includes a central processing unit (CPU) operably connected to memory, a display screen and a transmitter. Users selectively access the interactive monitor by transmitting a corresponding user identifier. Accordingly, upon approval the user is able to selectively access at least one group of programs for display.

In one illustrative example a system administrator creates an account for an account holder, which may be a pharmaceutical company, on the master computer, which is protected by login and password. The pharmaceutical company, or account holder, remotely accesses the master computer over the Internet and logs onto the account using the login and password. Once logged in, an interface permitting the uploading of files, i.e. programs or content, is presented together with menu options, which permit classification of the file. Exemplary menu options include a listing of medical departments and practice areas.

The account holder uploads a video file containing information for a newly approved pharmaceutical including its chemical name and FDA approved treatments. The account holder selects practice areas that correspond to FDA allowance from the menu. The information is submitted to the system administrator. The system administrator receives and reviews the submission. The video file is assigned to a plurality of user identifiers, which correspond to the selected practice areas.

A user having an earpiece capable of transmitting a user identifier initiates a connection with an interactive monitor within the medical campus through its transmission. Once authorized by the user, the interactive monitor obtains from the master computer a listing of options permitted by the user and displays them via the display screen. Among the displayed options the user selects the medications option. The user then selects the new pharmaceutical of interest. Once selected the video begins downloading to the interactive monitor the user instructs the interactive monitor to play the video. The user views the video portion through the display of the interactive monitor and the user's earpiece receives the accompanying audio.

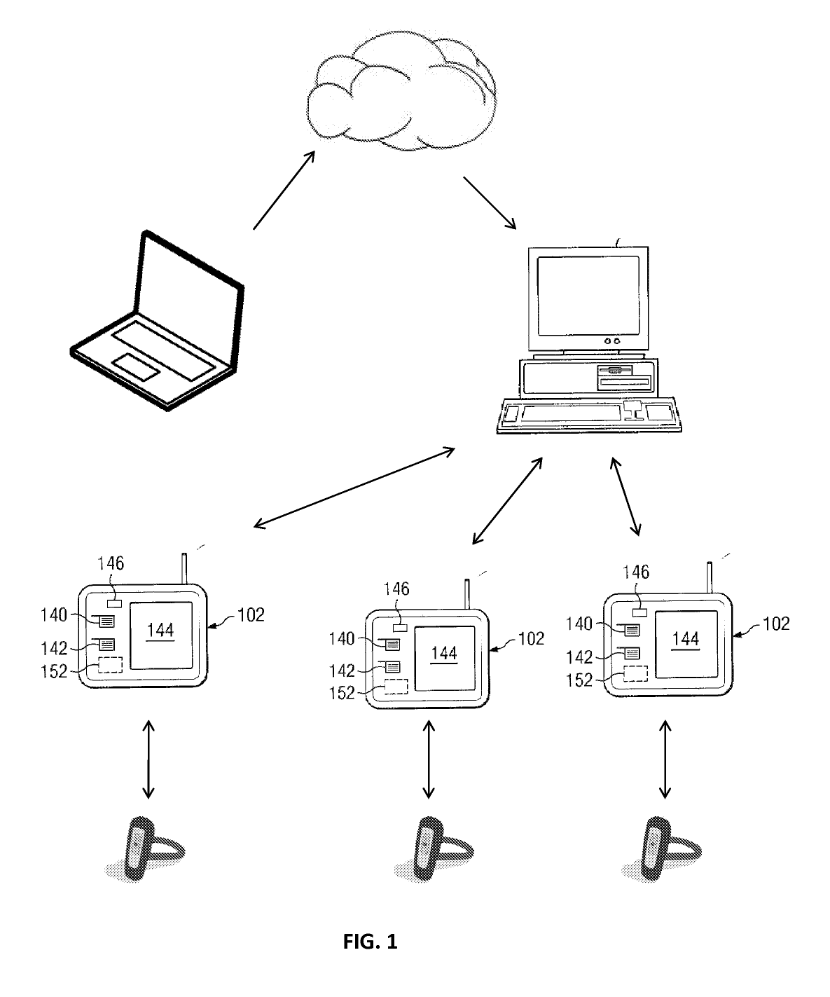

One embodiment is schematically illustrated in FIG. 1 wherein the laptop computer represents an account holder's terminal that is in communication with the master computer, illustrated by the desktop computer. The communication between them is schematically illustrated as the cloud, and one skilled in the art will appreciate the numerous methods and technologies that may be used to allow the account holder to access the master computer and supply content to the master computer. The master computer is illustrated in communication with three interactive monitors (102), although a healthcare campus is likely to have hundreds, if not thousands, of interactive monitors (102). FIG. 1 illustrates an earpiece in communication with the interactive monitors (102), although as previously disclosed any number of devices may be used to communicate with the interactive monitor (102) to establish a user ID.

In one embodiment the interactive monitor (102) displays at least one menu to ease user navigation. The embodiments illustrated in FIG. 1 include a first menu (140) and a second menu (142), which appear on the screen (144) of the interactive monitor (102), which may be a screen for a computer monitor or a screen for a television set. The user may initiate the interactive monitor (102) by a voice command using speech recognition technology (152). The user may chose either the first menu (140) or the second menu (142) by either physically activating the screen of the interactive monitor (102) at the appropriate first menu (140) or the second menu (142), or using speech recognition technology (152) of the interactive monitor (102) the user speaks their choice for the first menu (140) or the second menu (142), which is received by the voice-recognition technology (152) to activate the first menu (140) choice or the second menu (142) choice. Either the first menu (140) choice or the second menu (142) choice is sent to the video-output device as feedback. The feedback is received by the master computer and the associated CPU (103). The CPU (103) uses the feedback to select audio and video, only audio or only video from the content library stored in the memory (105). Using audio and video as an example, the CPU (103) directs the audio and video to the transmitter (108), and the transmitter (108) transmits the audio and video to the interactive monitor (102) to be received and played on the screen (144). In some embodiments this continues until the audio or video transmitted from the transmitter (108) ends or the user walks away from the interactive monitor, in the case of a stationary interactive monitor, at which point a sensor (36) fails to detect the user, or no longer is receiving the user I.D. The sensor (36) may direct the on/off mechanism (22) to turn off the interactive monitor (102), and the on/off mechanism (22) turns off the interactive monitor 102. A voice command may be used to turn off the interactive monitor (102) by utilizing the speech recognition technology (152). Alternatively, the programs may be downloaded from the master computer or directly input into an interactive monitor and saved in memory.

Various elements of one embodiment are illustrated in the functional block of FIG. 1. The interactive monitor (102) includes a central processing unit, or CPU (103), which controls operation of the interactive monitor. A memory (105), which may include both read-only memory (ROM) and random-access memories (RAM), provides instructions and data to the CPU (103). A portion of the memory (105) may also include non-volatile random-access memory. The display (109) provides a screen for CPU (103).

The interactive monitor (102) may include a housing (107), seen in FIG. 2, that contains a transmitter (108) and a receiver (110) to allow transmission and reception of data, such as audio and video communications and programming data, between the interactive monitor and the master computer. The transmitter (108) and the receiver (110) may be combined into a transceiver (112). The transmitter (108) and receiver (110) may be connected to transmit and receive data wirelessly, or via a wired connection. An antenna (114) may be attached to, or incorporated into, the housing (107) and electrically coupled to the transceiver (112). Although FIG. 1 illustrates the antenna (114) as extending from the housing (107), some designs may include an internal antenna that is contained completely within the housing. A user-input device (116) may include a video-input device (118) that is communicatively linked to the interactive monitor for operation by the user in a conventional manner. The user-input device (116) provides a convenient way which audio, commands, video images, voice data and other data may be entered by the user. Although FIG. 2 illustrates the user-input device (116) as including a video-input device (118), a microphone (120), a keypad (122), and a data-input jack (124), other user input devices may be used, such as the receiver, and the like, and in various combinations. In addition, while the video-input device (118) may be a camera, DVD, CD, or tape, other video-input devices (118) may be used, including the data-input jack (124), the receiver (110), and the like, and in various combinations. In some portable embodiments, the interactive monitor's components receive power from a battery (134), which is attached to and supported by the housing (107). In an exemplary embodiment, the battery (134) is a rechargeable battery. In other embodiments, the interactive monitor (102) may include a connector (not shown) for the connection of an external power source, such as an automobile power adapter, AC power adapter, or the like. The various components of the interactive monitor may be coupled together by a bus system (136), which may include a power bus, control bus, and status signal bus in addition to a data bus.

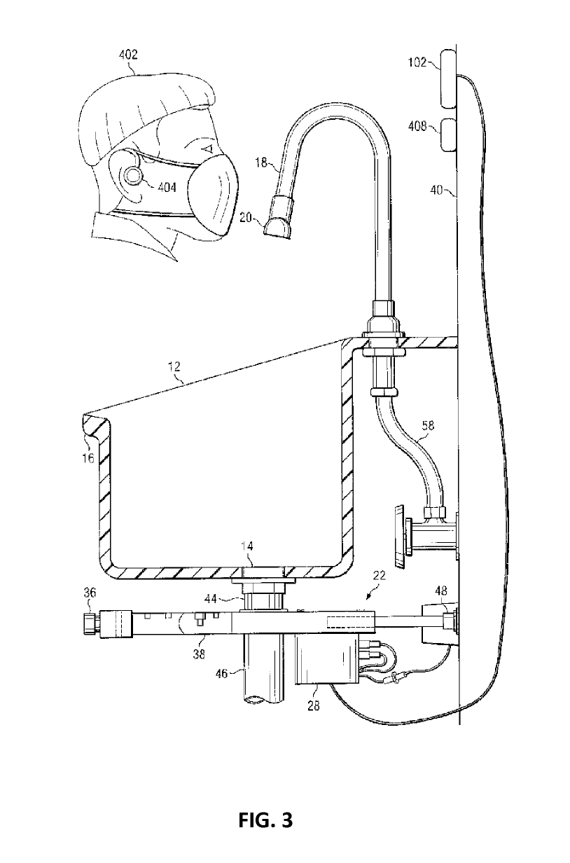

One, of many, installation locations of a stationary interactive monitor (102) is shown in FIG. 3. Here, a surgical scrub sink (10) is shown which includes a tub (12) and an interactive monitor (102). The tub (12) includes a drain hole (14) at its lower portion and a front edge (16). A faucet (18) is mounted at the top of tub (12). The faucet (18) terminates in a nozzle (20) which is disposed over and toward the open body of tub (12). In this embodiment the interactive monitor (102) is electronically operated by an on/off mechanism (22), or the wireless interactive monitor (102) may be voice-activated by user (402). The user (402) may use an ear piece (404), which may be attached to the user (402) before the user (402) washes their hands and may be removed by an attendant to maintain the sterile condition of the hands, as well as any of the previously disclosed technologies to let the interactive monitor identify the user by their user ID. In one embodiment the on/off mechanism (22) may include a solenoid controlled electronic switch in order to turn on and off the electric power for the interactive monitor (102) in housing (28). A sensor (36) may be mounted to the remote, or free end, of support arm. The support arm includes a main bracket (38) which is fixedly mounted to any suitable support. For example, the main bracket (38) is attached to drain tube (44) of tub (12) and is stabilized against rotation by a pair of wall adjustment screws bearing against wall (40). The position of sensor module (36) may be adjustable to its intended location with respect to the front edge (16) of tub (12). This assures that the module will detect the presence or absence of the user standing in front of and at or juxtaposed to front edge (16) of tub (12). Accordingly, it is possible to use a short focus sensor having an effective focal distance of about 2-6 inches and still reliably sense the presence or absence of a user standing at sink (10). The elevation of sensor (36) above the floor may be selected to correspond to the elevation of the user's, such as in the knee area. Other locations of the user's legs could also be used as the detecting target. In one embodiment the sensor module (36) may project a beam which operates to detect the presence or absence of an object in the range of the beam. Because sensor module (36) preferably operates with a focus, the presence of an object would be detected only when the object is in the immediate vicinity of front edge (16) at the elevation of sensor module (36). Thus, under ordinary conditions, no object would be detected. This detection of the absence of an object would permit the on/off mechanism (22) to remain in its off condition and the interactive monitor (102) would remain off. When, however, a user steps to sink (10) in order to perform a scrubbing operation by standing at the front edge (16) of sink (10), sensor module (36) would detect the presence of an object, namely the users legs and the sensing would be transmitted to on/off mechanism (22) and permit the interactive monitor (102) to be activated. The interactive monitor (102) would remain on as long as the user remained at the front of tub (12). Once the scrubbing operation has been completed, the user would step away from tub (12). Sensor (36) would then detect the absence of the user and corresponding signal would be sent to the on/off mechanism (22). The interactive monitor (102) would then shut off. Alternatively, as previously described, the sensor system may be replaced by using a short-range user identification system whereby the interactive monitor (102) simply stops playing the program when the wearable short-range device is no longer within the range of the interactive monitor (102).

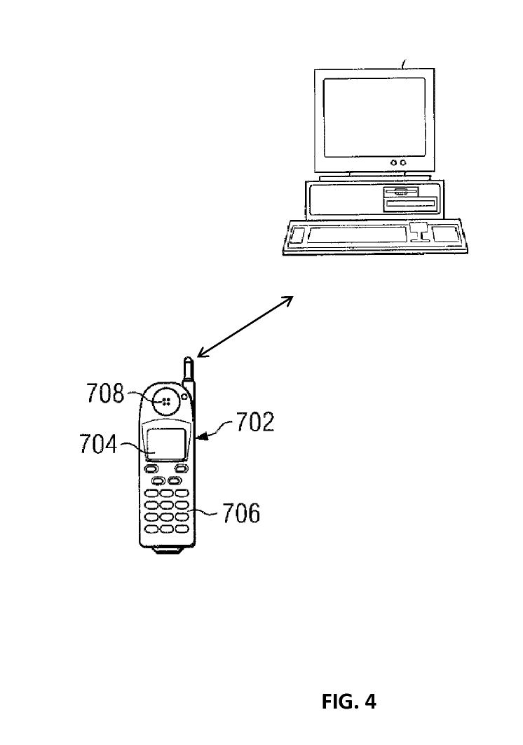

FIG. 4 illustrates an embodiment wherein the interactive monitor is a smartphone (702) in communication with the master computer, enabling a user to receive information in the form of video and audio through the display (704) and the speaker (708) and to provide feedback via voice commands, a touchscreen, or buttons (706), to the master computer in order to instruct the master computer as to which program the user would like to see and hear. The feedback would allow the user to take appropriate action to maintain or adjust the content of the program.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

I claim:

1. An interactive system for providing select medical or emergency information across a medical campus, comprising:
a) a master computer comprising software that receives, stores and transmits a plurality of programs comprising medical or emergency information, wherein transmission of the information is selectively accessed by a plurality of monitor identifiers;
b) a plurality of interactive monitors positioned in various locations across a medical campus, the interactive monitors comprising a central processing unit (CPU) operably connected to memory, a display screen and a transmitter, wherein the monitors each transmit a monitor identifier among the plurality of monitor identifiers to the master computer to authorize receipt of transmitted information, further wherein received information is selectively accessible to a plurality of users according to a plurality of user identifiers; and
c) a plurality of user transmitters that each transmit a user identifier among the plurality of user identifiers to a local interactive monitor among the plurality of interactive monitors for recognition by the CPU, wherein upon recognition of the user identifier the CPU permits access to at least one group of programs for display.

2. The interactive system according to claim 1, wherein the monitor identifier identifies the monitor as belonging to at least one of a plurality of monitor classes.

3. The interactive system according to claim 2, wherein the monitor identifier identifies the monitor as belonging to a monitor class selected from the group consisting of a physician's office, a physicians' lounge, a laboratory, an interventional radiology area, a radiology reading room, a utility instrument reading room, a sterilization room, a patient educational area and a pharmacy.

4. The interactive system according to claim 1, wherein the plurality of programs are selected from the group consisting of pharmaceutical information, medical device information, medical instruction information and emergency information.

5. The interactive system according to claim 1, wherein the interactive monitor is a wireless device loaded with a software application program that recognizes the user identifier, wherein the wireless device is selected from the group consisting of a smart phone, a laptop computer and a tablet computer.

6. The interactive system according to claim 1, wherein the user identifier is transmitted through blue tooth connectivity.

7. The interactive system according to claim 1, wherein the user transmitter transmits a Radio-frequency identification (RFID) signal.

8. An interactive system for providing select medical or emergency information across a medical campus, comprising:
a) a master computer comprising software that receives, stores and transmits a plurality of programs comprising medical or emergency information, wherein transmission of the information is selectively accessed by a plurality of user identifiers;
b) a plurality of interactive monitors for selective display of information positioned in various locations across a medical campus, each interactive monitor comprising a central processing unit (CPU) operably connected to memory, a display screen and a transmitter capable of receiving and transmitting the plurality of user identifiers; and
c) a plurality of user transmitters that each transmit a user identifier among the plurality of user identifiers to a local interactive monitor among the plurality of interactive monitors for recognition by the CPU, wherein upon recognition of the user identifier the master computer the local interactive monitor permits access to at least one group of programs for display.

9. The interactive system according to claim 8, wherein the interactive monitor is a wireless device loaded with a software application program that recognizes the user identifier, wherein the wireless device is selected from the group consisting of a smart phone, a laptop computer and a tablet computer.

10. The interactive system according to claim 8, wherein the user identifier is transmitted through blue tooth connectivity.

11. The interactive system according to claim 8, wherein the user transmitter transmits a Radio-frequency identification (RFID) signal.

12. A method of controlling dissemination of educational content to an interactive monitor system for a medical campus, comprising the steps of:
a) receiving a plurality of programs from an account holder;
b) associating, by at least one master computer, each of the programs with a plurality of user classes to create a content library;
c) associating, by the at least one master computer, each of a plurality of user identifiers with at least one of the plurality of user classes;
d) associating, by the at least one master computer, a plurality of interactive monitor ID's with a plurality of monitor classes to create a monitor permission database;
e) receiving a first interactive monitor ID from a first interactive monitor, and a first user identifier from the first interactive monitor; and
f) distributing at least one program from the content library to the first interactive monitor via the master computer, based upon the programs associated with the user class associated with the first user identifier, and the monitor class associated with the first interactive monitor ID.

13. The method of claim 12, further including the step of the first interactive monitor wirelessly receiving the first user identifier from a remote device.

14. The method of claim 12, further including the step of the at least one master computer receiving at least one user preference from a user associated with the first user identifier, and using the at least one user preference to determine the at least one program that is distributed to the first interactive monitor.

15. The method of claim 12, further including the step of receiving at least one emergency content program from the account holder and at least one emergency content program from a system administrator, and associating, by the at least one master computer, each of the emergency content programs with at least one emergency content class, and associating, by the at least one master computer, each of the plurality of user identifiers with at least one of the emergency content classes.
